(19) United States
(12) Patent Application Publication
(10) Pub. No.: US 2005/0146708 A1
(43) Pub. Date: Jul. 7, 2005

(54) Systems and methods for deformation measurement

(76) Inventors: Xunqing Shi, Singapore (SG); Zhiping Wang, Singapore (SG); Jason P. Pickering, Singapore (SG); Wei Fan, Singapore (SG)

Correspondence Address: Bradley B Geist;Baker Botts, 30 Rockefeller Plaza, New York, NY, 10112, US

(21) Appl. No.: 10/510,858

(22) PCT Filed: Apr. 11, 2002
(86) PCT No.: PCT/SG02/00058

(51) Int. Cl. G01L 1/24

(52) U.S. Cl. 356/35.5; 73/800

(57) ABSTRACT

A system for the real-time and in-situ macro and micro measurement of in-plane deformations of a microelectronic package or the like comprises a closed environmental chamber (3) within which a test sample may be subjected to thermal cycle loading and/or humidity loading, an incoherent white light source (6) for illuminating the sample, a long-working-distance microscope (2) and image acquisition means (7) for capturing speckle patterns from the surface of the sample during loading, and a control (8) for automating the co-ordination of the various components and for analysing the speckle images using digital image speckle correlation.

The present invention relates to systems and methods for measuring the deformation of objects. It is particularly applicable to the measurement of deformations of small samples and components, such as microelectronic packages, MEMs devices and the like.

Packaging technology has been broadly applied in the microelectronics industry in order to make products more personal, functional, reliable and less expensive.

Microelectronic packages are often multi-layered bonded structures, and an important consideration in their design is reliability.

Accordingly, various systems have been developed for testing microelectronic package designs in order to determine e.g. how they deform. These systems generally use optical measurement techniques, including Moire interferometry, geometric Moire techniques (such as shadow and projection Moire), laser speckle correlation and digital image correlation.

There are however various problems associated with the systems proposed to date. These range from the need for vibration damping precautions and the inability to conduct in-situ and real-time analyses, to the limited testing regimes available.

The present invention aims to provide new deformation measurement systems and methods, which, in their various aspects, are able to provide a number of advantages over the prior art.

Viewed from one aspect, the present invention provides a deformation measurement system, the system including an environmental chamber within which a sample under test is mounted and subject to load, a source of incoherent light for illuminating the-surface of the sample, a long-working-distance microscope for obtaining speckle image information from the illuminated sample surface, and analysing means for analysing the image information using a digital image speckle correlation technique.

A system in accordance with the present invention is able to provide versatile and accurate deformation testing of small objects, e.g. microelectronic packages, MEMs devices, and other small components or small samples of material, e.g. small composite structures. Typically, the sample size can range from for example about 0.26×0.35 mm² to about 61.4×81.9 mm².

The invention may for example be used in stress/stain analysis, thermal expansion coefficient measurements, thermal conductivity measurements, interfacial toughness measurements, and fracture propagation or toughness analysis.

The use of an incoherent light source, e.g. white light, with image correlation analysis reduces the need for anti-vibration precautions that might otherwise be required e.g. in a laser system using interferometric analysis. It can provide whole field views (as opposed for example to point or line scanning), can provide fast analysis of sample images, and can facilitate the real-time and in-situ analysis of a sample;

Further, the use of a long-working-distance microscope allows the vision system to work at long distances, so that for example the microscope and sample can be spaced well apart. This facilitates the use of an environmental chamber, and allows the lens to be spaced from e.g. a glass window of the chamber through which the chamber may be illuminated. It helps to avoid for example heat irradiation damage to the microscope's objective lens, and allows for direct imaging of the sample surface rather than e.g. imaging via an intermediate mirror or the like.

The environmental chamber itself can provide a controllable climate for a sample under test within the chamber. It can enable a sample to undergo various test regimes in e.g. a closed environment, and can allow for accurate simulation of real situations and testing over long time periods.

Overall, the system can facilitate the real-time, in-situ testing of microelectronic packages and the like under accurate loading conditions.

The chamber may include one or more heating and/or cooling device is so as to subject the sample under test to thermal loading.

Preferably, the chamber includes both heating and cooling elements, as this allows the sample to undergo cyclic testing under different heating and cooling regimes over time, with forced cooling occurring between times of heating.

The use of heating and cooling elements is particularly useful, as it allows a sample to be tested under more realistic circumstances than might otherwise be the case.

In one preferred embodiment, two heating elements are placed opposite one another in the chamber. A pair of cooling elements may also be placed opposite one another in the chamber, and a cooling element or heater may be provided at the base of the chamber. Thus, the chamber may have a cooler on its bottom, a heater on each of a pair of opposed sidewall, and a cooler on a further pair of opposed sidewalls.

The heaters may take any suitable form, and may for example be resistance heaters.

The coolers may also take any suitable form, and may for example be thermoelectric coolers. The coolers may be provided with suitable heat exchangers, e.g. mounted on their rears. These may be e.g. copper plate, and may include channels therein to increase the area of the heat sink.

The chamber may be configured to pass cooling fluid therethrough, e.g. chilled water, so as to provide a heat sink for the cooling elements. Circulation of the cooling fluid may be through one or more passages in the chamber walls, and may pass through the channels in the cooler heat exchangers. Suitable conduits may connect the chamber with suitable cooling equipment for the fluid, such as a water chiller.

The environmental chamber may also or alternatively provide humidity control, and the system may include a humidifier, either within the chamber itself or apart from but connected to the chamber, the latter being preferred.

The ability to provide a humidity-controlled environment is particularly useful in testing microelectronic packaging and MEMs devices that incorporate polymers in their construction.

The humidifier may comprise an ultrasonic humidifier. This may include an ultrasonic exciter located within a water container, e.g. at the bottom of the container. By controlling the amplitude of the exciter, different levels of moisture can be generated and flowed into the chamber.

The humidifier may also include a fan or other device for blowing resulting moist air into the chamber through a suitable conduit.

When providing humidity loading, heaters (and possibly coolers) may also be placed in the chamber to provide various humidities at various different temperatures. The invention can for example be used to apply isothermal loading in a humidity-controlled environment, in order to test e.g. electronics devices.

The humidifier may for example provide humidity environments from about 10% to about 95% RH at various temperatures.

Suitable monitoring devices may be provided in the chamber, such as a temperature sensor, e.g. in the form of a thermocouple, or a humidity sensor, e.g. in the form of a resistive sensor.

Preferably, the sensors are placed at the mid-height of the inner chamber, close to the test sample, as temperature and moisture may vary with height.

These monitoring devices may be used to provide feedback control of the thermal and/or humidity loading, and may also be used in the automatic recording of results when set load conditions are reached, e.g. a particular temperature, humidity or the like.

The loading of a sample, e.g. thermal or moisture loading, may be under automatic control to provide a suitable thermal cycle and/or humidity load test, and the system may include a controller for providing a set test regime, so that a user therefore need only input a desired loading cycle into the controller and let the system run. The system may also allow required measurements to be made and recorded automatically, e.g. at set temperatures or humidities or at set times in a load cycle, and so reduces the possibility of a required measurement being missed, e.g. through a user forgetting to make a manual record at a set time, temperature or humidity. This can be important, as tests may need to run overnight and can also last for up to three months for some accelerated load testing.

Whilst emphasis has been placed on thermal and/or humidity loading, the chamber may also or alternatively allow for other forms of loading, e.g. mechanical loading, and may include suitable means for applying such loads.

The chamber may include any suitable supports for mounting the sample in place during testing.

The environmental chamber preferably provides a closed environment, with substantially no air exchange with the surroundings during testing. The chamber therefore preferably includes one or more windows suitably transparent to the illumination light, in order to allow the sample to be illuminated and observed. The window (or windows) may, for example, comprise quartz crystal, and may be removable to allow for the insertion of a sample into the chamber. Sealing the chamber, and preventing air exchange, helps to reduce air disturbances in the chamber that might otherwise produce instability in the speckle images.

The interior size of the chamber is preferably kept small, so as to further reduce problems with air disturbances, and, in a preferred embodiment, is about 50×50×40 mm³. Such a size provides a suitably small testing space whilst also meeting the dimension requirements for typical electronics packages. Other sizes including larger sizes are also however possible, e.g. up to about 200×200×100 mm³. Too large a chamber size could prevent for example the thermoelectric coolers from providing low temperatures, e.g. 40° C. The chamber sizes are applicable to both thermal and humidity load chambers.

The small size also allows the chamber to quickly attain a state of equilibrium, e.g. a set humidity level, which again mitigates against air disturbances. Also, it is preferred to position the inlet port for the moist air in or near a corner of the chamber, so as to further reduce air disturbance. It is also preferred to provide a baffle or the like adjacent the inlet port, in order to prevent the flow of air directly onto the sample.

Although not essential, the chamber may be able to be evacuated of air e.g. using suitable pumping apparatus.

A humidity chamber and a thermal chamber may be replaced one for the other in the system, or for example two or more chambers may be arranged adjacent one another, e.g. on a suitable working table.

The long-working-distance microscope may take any suitable form. It may provide for a range of working distances from a few millimetres to several hundred millimetres. When mounted for movement above the chamber, for example, the long-working-distance microscope may have a working distance range of from e.g. about 32 mm to e.g. about 315 mm.

The microscope preferably includes a zoom component, so as to allow the microscope to view a sample on either a macro or micro scale, and to provide a global or local view.

Preferably, the microscope also includes an objective lens component separately adjustable from the zoom component, and the microscope is preferably configured so that it can be zoomed into or out of an area of interest in the sample using a one-time focus. Thus, once focussed, the objective lens can be fixed, and the microscope can be zoomed to view a larger or smaller area of the sample without losing focus.

One-time focussing facilitates the measurement of local and global deformations of areas of a sample that are of interest, and so measurement of micro and macro deformations, especially in real-time measurements.

The microscope preferably allows for a wide range of magnification, so that the sample may be viewed at various levels of detail. In one preferred embodiment, the microscope includes a number of TV tubes and objectives lenses, which may be switched to provide a number of different zoom and working distance ranges over which the system can work. For example, the microscope may include 2×, 1× and 0.5× TV tubes, for use with for example a 2× or 0.25× objective lens or with no objective lens.

The TV tubes provide a link between the upper zoom module and the video camera, and hold the camera at the correct image plane. Lower power TV tubes provide maximum field of view, while higher power TV tubes increase magnification on an associated monitor.

The microscope is preferably automatically-controlled, and preferably includes a zoom lens actuator and an objective lens actuator for varying the magnification and focussing. These actuators may comprise motors, such as stepper motors, and preferably also include positions sensors, such as suitable encoders, so as to track the positions of the zoom component and objective lens component and to provide feedback control.

The speckle patterns observed by the microscope may be recorded in any suitable manner, and are preferably stored in a digitised form that may then be suitably analysed.

In one preferred embodiment, the speckle patterns are recorded by a CCD camera that may be mounted on the microscope. Suitable electronics, such as an image card, may be provided to pass the CCD camera data to a computer for suitable processing.

The sample may be illuminated in any suitable manner. Illumination could be from within the environment chamber, but this could cause problems with accurate control of e.g. the chamber temperature. Preferably, the illumination source is mounted outside of the chamber.

Preferably, the light source is mounted so as to be directly overhead of the environmental chamber. This allows the light to be directed straight through the chamber window, and to directly illuminate the sample, the incident light being normal to the plane of the sample in which deformation is to be monitored. The long-working-distance microscope is preferably also positioned directly overhead, with its optical axis perpendicular to the plane in which deformations are to be monitored.

An advantage of such arrangements is that the speckle images obtained are not sensitive to out-of-plane deformations, e.g. changes in gray-levels caused by small out-of-plane deformations can be reduced or eliminated, and the system can provide more accurate correlation results, as compared to e.g. oblique illumination.

Preferably, the light source includes an illuminating device that is mounted for movement with the microscope, and is preferably mounted on the microscope.

Preferably, the light source includes a light ring provided about the working microscope.

Preferably, the actual source of light, i.e. generator of the light, is remote from the microscope. This prevents or reduces problems caused by heating of e.g. the objective lens of the microscope. Thus, preferably, light is channelled into a light ring or other suitable output element through a suitable guide, e.g. an optical fibre or the like. The light source may be e.g. a tungsten-halogen white light source.

The light source may be manually set, or may be automatically controlled in co-ordination with the other set-up parameters, such as zoom and focus control and loading controls, so as to ensure a suitable illumination intensity for a particular sample and loading regime.

Preferably, the microscope is able to move relative to the sample, so that different portions of the sample surface may be inspected. This is preferably achieved by moving the microscope rather than the sample, e.g. by providing the microscope on a suitable positioning means. Having the lighting device mounted to the microscope ensures that the sample is suitably lit no matter how the microscope is moved.

The movement system may comprise x-axis and y-axis translation stages, with preferably also a z-axis translation stage on which the microscope is mounted. Each stage may include a suitable actuator, such as a servo or stepper motor, which may for example operate a ballscrew arrangement. It may also include a position sensor, such as an encoder, for feedback control. The actuators and position sensors may be connected to x-, y- and z-stage controllers that in turn are controlled by a central control.

The mounting of the microscope on the z-axis stage preferably allows the direction of the microscope to be altered, e.g. so that the microscope can be held horizontally, and e.g. so that it can rotate about the xy plane. This allows the microscope to capture speckle images in different directions, which can be useful when the system is integrated with other testing equipment, such as a tensile testing machine or the like.

The microscope and environmental chamber may be mounted together, e.g. on a worktable or the like, to ensure that they are accurately registered with respect to one another.

The speckle images recorded by the system are analysed using a suitable digital image speckle correlation technique.

Preferably, the speckle images are analysed to find the maximum correlation coefficient C*:

$${C}^{*} ( {u}^{*} , {v}^{*} ) = \frac{{\sum }_{i = 1}^{m} {\sum }_{j = 1}^{n} [ f ( {x}_{i} , {y}_{j} ) - \overline{f} ] \cdot [ g ( {x}_{i}^{′} , {y}_{j}^{′} ) - \overline{g} ]}{\sqrt{{\sum }_{i = 1}^{m} {\sum }_{j = 1}^{n} {[ f ( {x}_{i} , {y}_{j} ) - \overline{f} ]}^{2}} \cdot \sqrt{{\sum }_{i = 1}^{m} {\sum }_{j = 1}^{n} {[ g ( {x}_{i}^{′} , {y}_{j}^{′} ) - \overline{g} ]}^{2}}} \qquad ( 1 )$$

where f(xᵢ,yⱼ) and g(x′ᵢ,y′ⱼ) are the gray-levels at points (xᵢ,yⱼ) and (x′ᵢ,y′ⱼ) on reference and deformed sub-images, respectively; and \overline{f} and \overline{g} are the mean values of gray-levels at points (xᵢ,yⱼ) and (x′ᵢ,y′ⱼ) respectively.

This differs from the standard correlation coefficient formula (as taught in e.g. “Digital Imaging Techniques in Experimental Stress Analysis”, W. H. Peters and W. F. Ranson, Optical Engineering, Vol. 21 pp. 42700431, 1982) through the introduction of the mean values. The peak in the distribution of equation (1) is sharper than that for the standard formula, and facilitates greater accuracy in the finding of the coefficient.

The system could use a coarse-fine search and Newton-Raphson partial differential method to correlate a pair of images (e.g. as disclosed in “Digital Image Correlation using Newton-Raphson Method of Partial Differential Correlation”, H. A. Bruck et al., Experimental Mechanics, Vol. 29, pp 261-267, 1989).

Preferably, however, a cross-search correlation algorithm is used, as this can provide high measurement accuracy and short computation time. The system-thus, preferably, finds the correlation coefficient peak point by a line search. Preferably, the algorithm searches for a maximum peak point along both the perpendicular (x,u) and horizontal (y,v) directions of the captured images for a maximum peak point from which displacement components can be determined. Such a search is faster than the coarse-fine search method, and can reduce the computational time by a factor of about 10, thereby facilitating the real-time measurement of sample deformation.

A preferred cross-search correlation algorithm is disclosed in e.g. “Nondestructive defect detection in multilayer ceramic capacitors using an improved digital speckle correlation method with wavelet packet noise reduction processing”, IEEE Transactions on Advanced Packaging, Vol.23, pp. 80-87, 2000, Y. C. Chen, K. C. Hung and X. Dai (the contents of which are incorporated herein by reference).

Information on such cross-search correlation algorithms can also be found in “A new digital speckle correlation method and its application”, J. B. Rui et al, Acta Mech. Sinica, Vol.26, pp 599-607, 1994, and “Nondestructive Detection of Defects in Miniaturized Multilayer Ceramic Capacitors Using Digital Speckle Correlation Techniques”, Y. C. Chen et al, IEEE Transactions on Components, Packaging, and Manufacturing Technology—Part A, Vol. 18, No. 3, 1995, pp 677-684 (the contents of which are also incorporated herein by reference).

Preferably, the discrete gray-level data obtained from e.g. the CCD camera is smoothed using a bicubic spline interpolation method. Bicubic spline interpolation is a known interpolation method, details of which can be found in e.g. the text book Spath H., “Two dimensional spline interpolation algorithms, A K Peters, Wellesley, Mass., 1995.

The bicubic spline interpolation allows for sub-pixel processing, and enables gray-level values to be determined for any position in the images, even though the characteristics of the recording device, e.g. video camera and digitising circuits provide a discrete gray-level output with no gray-level information between pixels. The use of the bicubic spline interpolation method can help the correlation algorithm to find a more accurate position for C*, and it has been found, in practice, that an accuracy of 0.01 pixel can be obtained.

The system preferably includes a central control for co-ordinating the various operating modules, such as an environmental chamber module, a positioning module, a zooming and focus module, an image-capture module and an analysis module. By integrating all of these control features, the system can run by itself after for example the input of a suitable loading regime. This can be especially useful when conducting for example accelerated thermal cycling tests (ATC) over long time periods. These tests may for example take in the region of two to three months to complete 1000 loading cycles (the minimum requirement for a reliability test).

Further, the system prevents a user from missing test data when for example a test is run overnight.

The system can preferably record position information, and preferably also magnification information, for a particular speckle pattern record of a sample, in order to allow for the simple relocation of the microscope in relation to the sample when the sample is returned for measurement after removal. This enables a second speckle pattern to be taken at the same position and magnification. The two speckle patterns may then be analysed to determine any change in the sample structure, e.g. after the sample has been exposed to load in the field.

The present invention further extends to methods in accordance with the features of the above systems, and to environmental chambers for use in such systems

Thus, viewed from a further aspect, the present invention provides a method for deformation measurement, the method including the steps of placing a sample to be tested within an environmental chamber, illuminating the surface of the sample with incoherent light, obtaining speckle image information from the illuminated sample using a long-working-distance microscope when the sample is under one or more load conditions, and analysing the image information obtained using a digital image speckle correlation technique.

The present invention can also be seen to provide an environmental test chamber for use in the digital image speckle correlation testing of a sample, the chamber including an inner chamber in which the sample is mounted, a window (which may be removable for closing the inner chamber) that is transparent to the illuminating radiation used in the test, a support for the sample, and thermal and/or humidity loading means for applying a thermal and/or humidity loading to the sample.

The use of the long distance microscope is in itself an important feature, and, viewed from another aspect, the present invention provides an apparatus for the deformation testing of an object, the apparatus including a source of incoherent light for illuminating a sample under test, and a long-working-distance microscope for obtaining speckle image information from the illuminated sample surface, the image information being analysed using a digital image speckle correlation technique.

The use of a long-working-distance microscope allows the system to be extended to capture images of a sample in a process, for example in a curing process or in a reflow process.

The long-working-distance microscope can be used separately in a production line (e.g. in a curing or reflow process) to capture images. The correlation software is then used to correlate the images to determine the deformation.

The microscope can be combined with normal material testing systems, e.g. tensile testing machines and fatigue testing machines, and can measure the micro- and macro-deformation of samples subjected to mechanical loading.

The use of the environmental chamber is also in itself an important feature, and, viewed from a further aspect, the present invention provides apparatus for the deformation measurement of a sample, the apparatus including an environmental chamber within which a sample under test is mounted in use, a source of incoherent light for illuminating the surface of the sample, and a means for obtaining speckle image information from the illuminated sample surface, the image information being analysed using a digital image speckle correlation technique. Such a system could be used with any type of microscope, although the use with a long-working-distance microscope provides the previously described advantages.

The preferred correlation methods discussed above, rather than e.g. a Newton-Raphson method, are also advantageous in themselves, and, viewed from another aspect, the present invention provides deformation measurement apparatus, the apparatus including a source of incoherent light for illuminating the surface of the sample, and means for obtaining speckle image information from the illuminated sample surface, the image information being analysed using a digital image speckle correlation technique in which the speckle image information is analysed to find a maximum correlation coefficient C*:

$${C}^{*} ( {u}^{*} , {v}^{*} ) = \frac{{\sum }_{i = 1}^{m} {\sum }_{j = 1}^{n} [ f ( {x}_{i} , {y}_{j} ) - \overline{f} ] \cdot [ g ( {x}_{i}^{′} , {y}_{j}^{′} ) - \overline{g} ]}{\sqrt{{\sum }_{i = 1}^{m} {\sum }_{j = 1}^{n} {[ f ( {x}_{i} , {y}_{j} ) - \overline{f} ]}^{2}} \cdot \sqrt{{\sum }_{i = 1}^{m} {\sum }_{j = 1}^{n} {[ g ( {x}_{i}^{′} , {y}_{j}^{′} ) - \overline{g} ]}^{2}}}$$

where f(xᵢ,yⱼ) and g(xᵢ,yⱼ) are the gray-levels at points (xᵢ,yⱼ) and (x′ᵢ,y′ⱼ) on reference and deformed sub-images, respectively; and \overline{f} and \overline{g} are mean values of gray-levels at points (xᵢ,yⱼ) and (x′ᵢ,y′ⱼ) respectively.

Preferably, a cross-search correlation algorithm is used to find the maximum correlation coefficient C*. Preferably, the maximum correlation coefficient is found by a line search, in which a search is made along both the x and y directions of the captured images for a maximum peak point for the correlation coefficient. Also preferably, the discrete gray-level data obtained from the image information is smoothed using a bicubic spline interpolation method.

Viewed from a further aspect, the present invention provides a deformation measurement method for determining the deformation of a sample using digital image speckle correlation, including the steps of:
obtaining gray-level image information of two or more speckle images of the sample;
smoothing the gray-level image information using a bicubic spline interpolation method; and
determining the position of a correlation coefficient peak for the images from the smoothed gray-level image information.

These various further aspects of the present invention may also include any of the other features mentioned above in relation to the first aspect of the present invention.

It would also be possible to replace the white light used in the above systems with coherent light e.g. from a laser, and to use appropriate speckle interferometry as known in the art.

It should be noted that the various control functions of the system can be implemented in various ways using for example a personal computer or the like and suitable control and correlation software embodying the inventive concepts as would be understood by a person skilled in the art.

An embodiment of the present invention will now be described, by way of example only, with reference to the accompanying drawings. It is to be understood that the particularity of the drawings does not supersede the generality of the preceding description of the invention.

In the drawings:

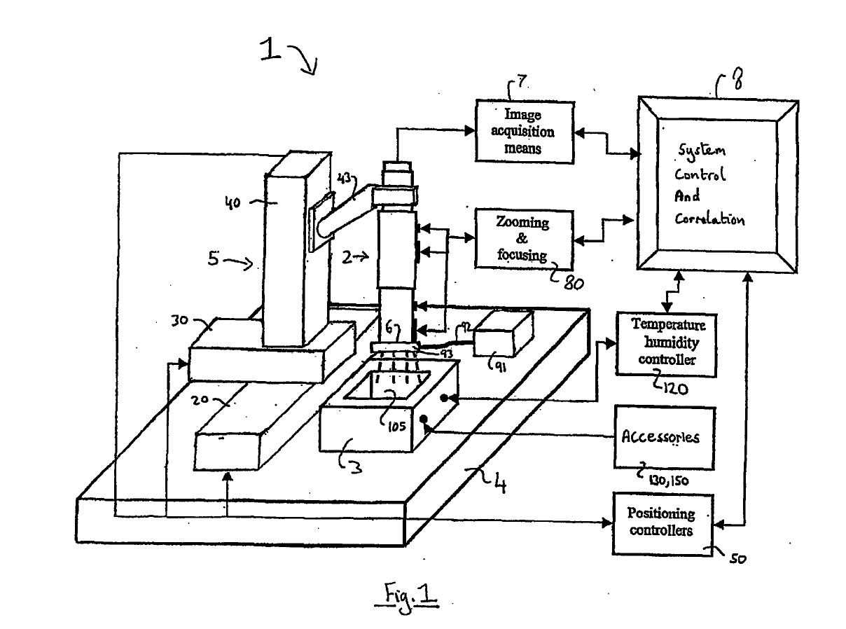

FIG. 1 is a schematic diagram of the overall set-up of a measurement system in accordance with one embodiment of the present invention;

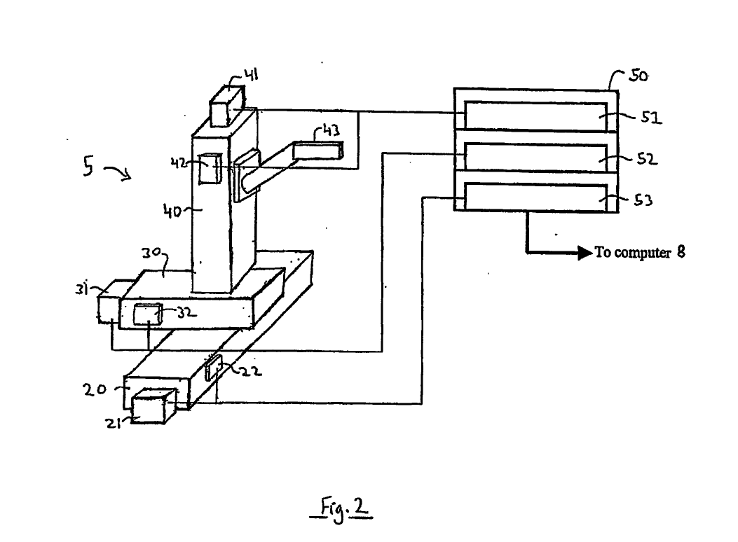

FIG. 2 is a schematic diagram of the object positioning and control means of the system of FIG. 1;

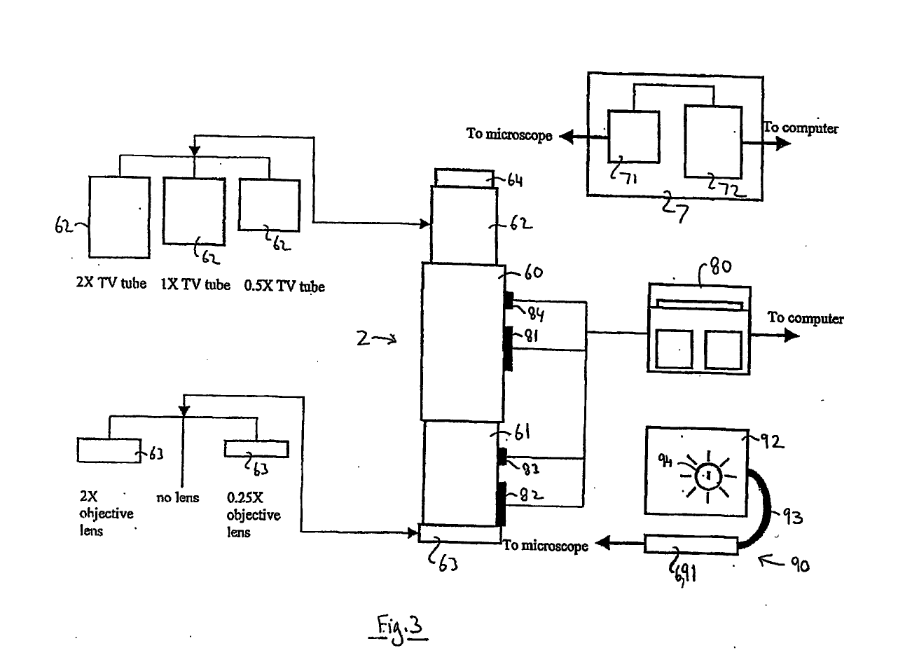

FIG. 3 is a schematic diagram of the long-working-distance microscope of the system of FIG. 1;

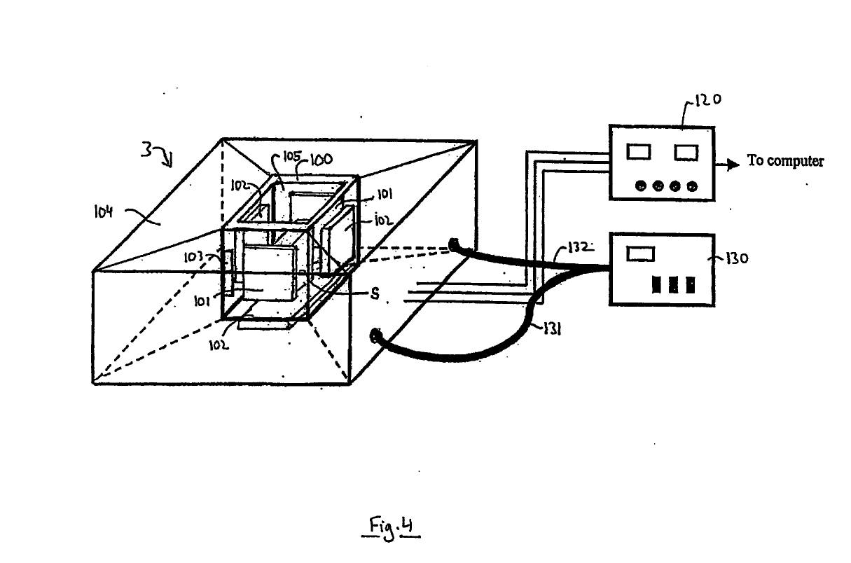

FIG. 4 is a schematic diagram of a mini-thermal cycling chamber for use in the system of FIG. 1;

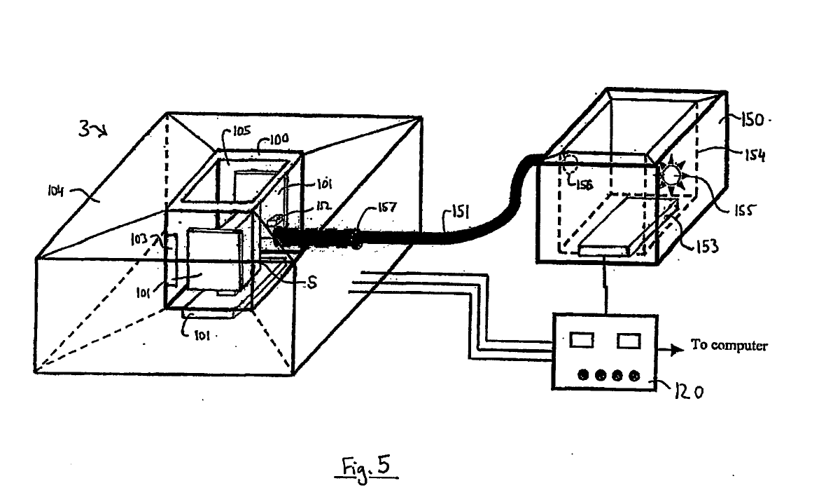

FIG. 5 s a schematic diagram of a mini-humidity chamber for use in the system of FIG. 1; and

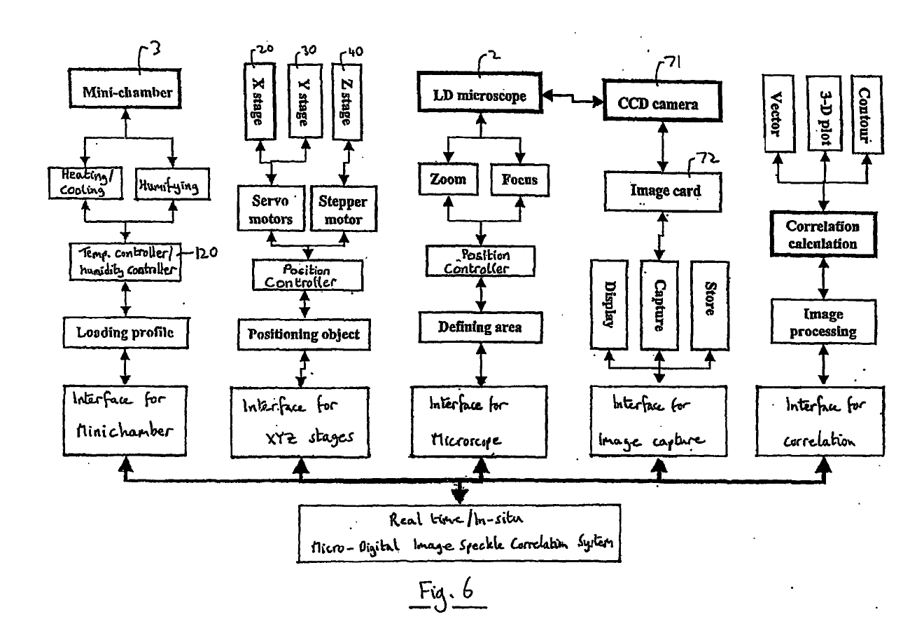

FIG. 6 is a schematic diagram of the correlation analysis and system control of the system of FIG. 1.

An integrated, automatic, non-contact and non-destructive micro-digital image speckle correlation system 1 for detecting macro and micro scale in-plane deformations of a micro-electronic package is shown in FIG. 1.

The system 1 includes a long-working-distance microscope 2 and an environmental chamber 3 mounted on a working table 4.

The microscope 2 is mounted to the table 4 via a three-dimensional positioning apparatus 5. An illumination device 6 is mounted to the objective lens end of the microscope 2 in order to illuminate a sample in the environmental chamber 3, and a suitable image acquisition means 7 is connected to the TV tube end of the microscope 2.

In use, a sample such as a micro-electronic package is positioned within the chamber 3 and subjected to thermal and/or humidity loading. The resulting deformation of the sample is analysed using speckle patterns observed by the microscope 2.

Thus, a reference speckle pattern may be obtained prior to loading, and then one or more further patterns obtained during and/or after loading. These patterns may then be converted into sets of gray-scale values that can be compared with one another to determine how the sample has deformed (Translational movement of parts of one pattern in relation to the corresponding parts of another pattern can be related to in-plane movement of the sample).

The system includes an overall system controller 8 that runs the test, collects the results, and analyses the speckle patterns in order to determine the sample deformation. The controller 8 may for example take the form of a standard computer with suitable control and analysis software.

The system 1 can be considered to consist of four main parts: an object positioning subsystem; an object vision and image acquisition subsystem; an object loading subsystem; and a correlation and system control subsystem. These subsystems are described separately.

The object positioning subsystem is shown in FIG. 2, and includes the three dimensional positioning apparatus 5 and a positioning controller 50 connected to the system controller 8.

The positioning apparatus 5 includes separate X,Y and Z-stages 20, 30 and 40 respectively, and the position controller 50 comprises X,Y and Z-stage sub-controllers 51-53.

Each stage 20-40 has a motor 21, 31, 41 and a position sensor 22, 32, 42 connected to their respective sub-controllers 51-53. This allows the sub-controllers 51-53 to control the position of the X,Y and Z-stages 20-40 in a feedback manner to provide accurate positioning of the microscope 2, in accordance with instructions from the central controller 8.

The microscope 2 is mounted on the Z-stage 40 of the positioning apparatus 5 by a fixed arm 43.

The positioning subsystem allows the microscope 2 to be located at any desired height above the environmental chamber 3 (i.e. in the Z-direction), depending on the size of the sample and the area size to be analysed.

It also allows the microscope 2 to move to any desired point in the X-Y plane depending on the location of the sample in the chamber 3 and on the area of the sample to be analysed.

The object vision and image acquisition subsystem is shown in FIG. 3, and includes the long-working-distance microscope 2, the illumination device 6, and the image acquisition means 7.

The microscope 2 includes a zoom module 60 and a focus module 61 for separately zooming and focussing the microscope 2 under control of a zooming and focussing controller 80 through the use of stepper motors 81, 82 and position sensors 83, 84 for feedback control.

In order to vary its magnification range and working distance, the microscope 2 includes replaceable TV tubes 62 and replaceable objective lenses 63. As an example, the various combinations of TV tube 62 and objective lens 63 may provide the magnification ranges and working distances shown in Table 1:

TABLE 1

| | 0.5× | | 1.0× | | 2.0× | |
|---|---|---|---|---|---|---|
| | Low | High | Low | High | Low | High |
| 0.25 × | 3.22 | 32.2 | 6.6 | 66 | 12.8 | 128 |
| (315 mm) | | | | | | |
| 1.0 × | 12.8 | 128 | 26 | 260 | 53.66 | 516 |
| No Lens | | | | | | |
| (89 mm) | | | | | | |
| 2.0 × | 26 | 260 | 53.66 | 56 | 103.2 | 1032 |
| (32 mm) | | | | | | |

(Figures in brackets are the corresponding Working Distances)
(The table is based on a ½″ CCD camera and 13″ monitor)

The microscope 2 can thus zoom into or out of the sample under test so as to measure macro or micro deformations, and to either provide a global view of the sample or a more localised view of a particular area of interest

The microscope 2 allows for a one-time focus of the sample. Thus, once focus is achieved by focussing module 61, the microscope can zoom into and out of the sample using zoom module 60 without affecting focus. This provides for quick and simple zooming into areas of particular interest in the sample, especially during real-time analysis and viewing.

The illumination device 6 comprises an objective ring light 91 which is a part of a general lighting unit 90 that also includes a light generator 92 and a fibre optic cable 93 for coupling light from the generator 92 to the light ring 91.

The intensity of the light may be varied by a user turning a control knob 94 to a suitable position. The light is then conducted by the fibre optic cable 93 to the objective ring light 91 from which it illuminates the sample in the environmental chamber 2.

Having the light generator 92, e.g. a tungsten-halogen generator, remote from the microscope 2 prevents problems with the heating of the objective lens 63, whilst having the light ring 91 on the microscope 2 provides uniform illumination of the sample, and allows for direct straight-line illumination into the environmental chamber 3, so that the incident light beam is normal to the plane in which the sample deformation is being determined. The arrangement also allows the microscope 2 to be mounted directly above the sample in a straight-line manner.

Generally, the illumination intensity will be set manually via the control knob 94 and kept at this value for an entire test run. The generator 92 could, however, also be connected to the system controller 8 for setting and changing illumination where necessary.

By mounting the illumination device 6 on the microscope 2, movement of the microscope to a new inspection position also causes movement of the light source. Thus, the illuminating device 6 is automatically moved to the correct position.

The speckle patterns produced by the sample under test and imaged in the microscope 2 are recorded by the image acquisition means 7, which may comprise a CCD camera 71 and an image card 72. The CCD camera 71 is connected to the microscope 2 via a mount coupler 64, and the image card 72 digitises the CCD image and sends it to the central control 8 for processing.

A sample loading subsystem is shown in both FIGS. 4 and 5. The first subsystem is used to apply a thermal load to a sample, and the second is used to apply a humidity load to a sample.

Referring firstly to FIG. 4, the sample loading subsystem comprises the environmental chamber 3, a load (in this case temperature) controller 120, and a water-cooling chiller 130.

The chamber 3 includes an inner chamber 100 within which is mounted a sample S, a pair of resistance heaters 101, three thermoelectric coolers 102 (on opposed side walls and the bottom of the chamber 100), and a thermocouple temperature sensor 103.

The inner chamber 100 is surrounded by heat insulating material 104, such as ceramic cotton, and has a quartz glass window 105 through which the sample S may be illuminated and the speckle patterns produced by its surface observed.

The temperature controller 120 is connected to the central controller 8, and activates the heaters 101 and coolers 102 in order to produce the required temperature in the inner chamber 100, as monitored by the sensor 103 (which is mounted at about the mid-height of the inner chamber 100). The required temperature may be determined by a thermal cycling regime input into the central controller 8, so as to e.g. provide an accelerated thermal cycling test.

Water chilled by the chiller 130 is supplied to the coolers 102 via supply and return conduits 131 and 132. This water is circulated through small channels in copper heat exchangers associated with each of the coolers 102 in order to cool them and to provide a sink for the heat taken from the inner chamber 100.

Referring now to FIG. 5, the humidity subsystem is shown.

The subsystem of FIG. 5 is similar to that of FIG. 4, and includes inner chamber 100, sample S, heaters 101, thermocouple temperature sensor 103, heat insulating material 104 and a quartz glass window 105.

Instead of thermoelectric coolers and chilled water circulation, however, the subsystem includes a humidifier 150 that delivers moist air to the inner chamber 100 via a conduit 151. Also, the load controller 120 is in this case a humidity controller, which controls the humidifier 150 to provide a desired humidity load as entered into the central controller 8, and as monitored by a humidity sensor 152 for feedback control and the like (which is mounted at about the mid-height of the inner chamber 100). A further heater 101 is also supplied in the base of the inner chamber 100.

The humidifier 150 includes a high power ultrasonic exciter 153 located at the bottom of a water box 154. Moist air is produced through the vibration of water in the water box 154 by the exciter 153, and is blown into the inner chamber 100 by the electric fan 155 through humidifier port 156, conduit 151 and chamber port 157.

Although riot shown as such in the drawings, the chamber port 157 is preferably provided at or near a corner of the inner chamber 100, so as to reduce air disturbances about the sample S to a minimum. Air disturbances might distort the speckle patterns imaged by the microscope 2, which could adversely affect the results of the deformation analysis.

A baffle (again not shown) may also be provided adjacent the chamber port 157, so as to prevent the air from passing directly towards the sample S.

The fact that the chambers 3 are closed from the surrounding air by the glass window 105 also significantly prevents air disturbances in both the temperature loading-and humidity loading chambers. Furthermore, the chambers 3 are miniature chambers, with the inner chamber 100 being of a small size. This enables the environment within the inner chamber 100 to respond to changes in load e.g. from the heaters 101, coolers 102 and/or the humidifier 150, and to stabilize quickly after a load change. This again reduces problems with air disturbances.

In one preferred embodiment, the inner chamber 100 has dimensions 50×50×40 mm³ in the length, width and height directions respectively, although larger sizes are possible, e.g. up to 200×200×100 mm³. Such dimensions provide a suitably small volume to avoid problems with air disturbances, whilst meeting the requirements for typical small electronics packages that may range in size between e.g. about 5×5×0.5 mm³ to about e.g. 40×40×5 mm³. The size of the-whole chamber 3, could for example be in the region of 180(L)×180(W)×90(H).

The thermal load and humidity load chambers 3 may be replaceable one with the other in the working table 4, or may be provided one adjacent the other in the table 4.

The correlation and system control subsystem, which is embodied in the central controller 8, is shown in FIG. 6, and comprises five general modules.

The chamber control module controls the environment chamber 3, and the thermal cycling and/or humidity load. It can be used to generate temperature and/or humidity loading-profiles, to monitor temperature and/or humidity levels, and save actual test regime data, e.g. temperature and/or humidity level histories.

The stage control module drives the XYZ translation stages, and can be used to search an object, and record and recall the position of an object.

The microscope control module is used to automatically zoom and focus the object. The lens and TV tubes used, and the corresponding working distance and magnification, may be displayed by the module.

The image acquisition module captures, saves and displays the image of the object.

The correlation module correlates a pair of captured images, calculates the deformation, and visualizes the measurement in e.g. three ways, such as a contour line, a 3-D plot and/or a displacement vector image. The system may provide a 2-D contour plot for U,V field displacement, x,y direction normal strain and x,y plane shear strain; a 3-D surface plot for U,V field displacement, x,y direction normal strain and x,y plane shear strain; and/or a 2-D vector graph for U,V field displacement.

As said, the system control and correlation module may be provided as a standard computer with suitable analysis and control software, as would be understood by a person skilled in the art.

Overall, in order to conduct a test, a sample, such as a microelectronic package is placed in the appropriate environmental chamber, and the glass window 105 is closed over the chamber to seal the sample inside.

The microscope is positioned to image the area of the sample of interest, and a suitable loading regime is then programmed into the central controller, together with instructions on when to record speckle images, e.g. at set loadings or at set times.

The system then runs automatically, with the controller 8 instructing the temperature and/or humidity controller 120 accordingly.

The system also allows a user to examine the whole surface of the sample, and to move to, and zoom down to, a specific region of interest and view that area on a local scale, the results being shown in real-time as the sample load and/or viewing scale changes.

The environmental chambers allow the samples to be tested under regimes similar to those that they will experience in use, and allow for accelerated thermal tests and the like to be simply carried out.

The positioning subsystem is able to record the position of a sample and of a particular view, so that an initial speckle pattern may be obtained for a particular area of a sample of interest, and then the sample removed and subjected to loads and the like in the field. The sample may then be returned to the measuring system, which can recall the microscope position (and magnification), and so can accurately provide a speckle pattern for the same area as the original speckle pattern. These patterns can then be compared, and changes in the area of interest noted.

Generally, the analysis will be of in-plane deformations of the sample, e.g. stress and strains information, as these deformations correspond to translational movement of parts of the speckle images recorded.

With regard to the details of the digital image speckle correlation analysis itself, if an object is illuminated with white light and if the surface of the object is, such as to produce random reflections (as is often the case), then a surface pattern can be obtained of random gray-levels at different points on the surface.

On deformation of the sample, this pattern changes, and the principle of digital image speckle correlation is to capture these patterns, digitise them and compare the digital images, in order to determine how the images have changed and to relate these changes to sample deformation.

In digital image speckle correlation, a search is conducted of the same points in an image of the object both-before and after loading. Assuming that point F(x,y) is in an image subset of m×n pixels of the image prior to loading, then searching of its position G(x′,y′) in the image after deformation can be performed based on the two sub-images using a correlation coefficient:

$${C}^{*} ( {u}^{*} , {v}^{*} ) = \frac{{\sum }_{i = 1}^{m} {\sum }_{j = 1}^{n} [ f ( {x}_{i} , {y}_{j} ) - \overline{f} ] \cdot [ g ( {x}_{i}^{′} , {y}_{j}^{′} ) - \overline{g} ]}{\sqrt{{\sum }_{i = 1}^{m} {\sum }_{j = 1}^{n} {[ f ( {x}_{i} , {y}_{j} ) - \overline{f} ]}^{2}} \cdot \sqrt{{\sum }_{i = 1}^{m} {\sum }_{j = 1}^{n} {[ g ( {x}_{i}^{′} , {y}_{j}^{′} ) - \overline{g} ]}^{2}}}$$

where C* is the correlation coefficient; f(xᵢ,yⱼ) and g(x′ᵢ,y′ⱼ) are the gray-levels at points (xᵢ,yⱼ) and (x′ᵢ,y′ⱼ) on the reference and deformed sub-images, respectively; and \overline{f} and \overline{g} are the mean values of gray-levels at points (xᵢ,yⱼ) and (x′ᵢ,y′ⱼ) respectively.

According to the principles of probability and statistics (see e.g. “A new digital speckle correlation method and its application”, Acta Mech. Sinica, Vol. 26, pp. 599-607, 1994, J. B. Rui, G. C. Jin and B. Y. Xu), if the two random variables f(xᵢ,yⱼ) and g(x′ᵢ,y′ⱼ) are related, the correlation coefficient distribution of the above equation has unimodal character and approximate symmetry.

In order to reduce computational time to meet the requirements of real-time measurements and to improve measuring accuracy, a cross-correlation method is used in the present method to find a peak for the coefficient. Details of the cross-correlation method may be found in “Nondestructive defect detection in multilayer ceramic capacitors using an improved digital speckle correlation method with wavelet packet noise reduction processing”, IEEE Transactions on Advanced Packaging, Vol. 23, pp. 80-87, 2000, Y. C. Chen, K. C. Hung and X. Dai (the contents of which are incorporated herein by reference).

The principle of this cross-correlation algorithm is to search on the profile of the peak along the perpendicular (V or y) direction and then along the horizontal (U or x) direction until the maximum peak point is found, from which displacement components u(x,y) and v(x,y) can be determined.

The operational characteristics of video cameras and digitisation circuits are such that the gray-level obtained of the speckle images are discrete in nature, with no gray-level information being available between pixels. In order to provide sub-pixel processing, and to enable gray-level values to be determined for any position in the images, the discrete gray-level data obtained from e.g. the CCD camera is smoothed using a bicubic spline interpolation method. The use of the bicubic spline interpolation method allows the correlation algorithm to find a more accurate position for the correlation coefficient C*, and it has been found, in practice, that an accuracy of 0.01 pixel can be obtained.

The present invention may be applied to measure in-situ macro- and micro-scale deformation for small amounts of materials and small components as they are subjected to thermal and/or humidity loading.

The invention may be used to monitor for example real-time crack propagation of film/substrate-bonded systems; to investigate displacement and strain singularity fields around crack tips in bi-material bonded systems; to characterise fracture toughness for various (thin) films used in microelectronic packages; to analyse interfacial toughness for various polymer/inorganic bi-material bonded systems; to determine residual stress caused by different packaging processes, e.g. a curing process or a reflow process; to measure the coefficient of thermal expansion (CTE) for small amounts of materials and the global CTE for microelectronic packaging components; and to determine the thermal conductivity for small amounts of materials involved in microelectronic packages.

The system may be combined with common material testing machines, e.g. tensile testing machines, fatigue testing machines and/or creep testing machines, to measure the deformation of a specimen under mechanical loading. For example, a holder may be designed to allow the microscope to be held in the horizontal direction, with adjustable rotation in the xy plane. The long-distance-working microscope can then be focussed on the surface of a specimen, speckle images recorded before and after loading, and the deformation determined by the correlation software.

When combined with common material testing machines, the system can be used to carry out various material testing, including: characterisation of mechanical properties of various materials, especially for film specimens; measurement of Poisson ratios for different materials involved in microelectronics packages; monotonic tests, such as tension, compression and shear tests, on small amounts of materials and small components; cyclic tests, e.g. fatigue tests, on small amounts of materials and small components; and constant load tests, e.g. creep tests, on small amounts of materials and small components.

It is to be understood that various alterations, additions and/or modifications may be made to the parts previously described without departing from the ambit of the present invention.

1. A deformation measurement system, the system including an environmental chamber within which a sample under test is mounted and subject to load, a source of incoherent light for illuminating the surface of the sample, a long-working-distance microscope for obtaining speckle image information from the illuminated sample surface, and analysing means for analysing the image information using a digital image speckle correlation technique.

2. The system of claim 1, wherein the environmental chamber is a closed chamber, and includes a window therein transparent to the illuminating light.

3. The system of claim 1, wherein the chamber includes one or more heating devices.

4. The system of claim 3, wherein the heating devices are resistive heating elements.

5. The system of claim 1, wherein the chamber includes one or more cooling devices.

6. The system of claim 5, wherein the cooling devices comprise thermoelectric cooling elements.

7. The system of claim 1, wherein the chamber includes a cooling deice at its base, a heating de vice at each of a pair of opposed side walls, and a cooling device at each of a further pair of opposed side walls.

8. The system of claim 5, wherein the system includes a source of cooling fluid to provide a heat sink for the cooling devices.

9. The system of claim 1, wherein the environmental chamber provides humidity control, and wherein the system includes a humidifier.

10. The system of claim 9, wherein the humidifier comprises an ultrasonic humidifier.

11. The system of claim 1, wherein the chamber includes one or more load sensors for monitoring the load on the sample.

12. The system of claim 11, wherein the load sensor comprises a temperature sensor.

13. The system of claim 11, wherein the load sensor comprises a humidity sensor.

14. The system of claim 1, wherein illumination of the sample is substantially normal to the plane of the sample in which deformation is measured.

15. The system of claim 1, wherein the microscope is mounted such that its optical axis is substantially normal to the plane of the sample in which deformation is measured.

16. The system of claim 1, wherein the microscope includes a zoom component.

17. The system of claim 16, wherein the microscope includes an objective lens component separately adjustable from the zoom component, and the microscope is configured so that it can be zoomed into or out of an area of interest in the sample by using a one-time focus.

18. The system of claim 1, wherein the microscope includes a plurality of interchangeable TV tubes and objective lenses.

19. The system of claim 1, wherein the system includes image acquisition means for recording speckle image formation in digitised form.

20. The system of claim 1, wherein the system includes a CCD camera for obtaining speckle image information.

21. The system of claim 1, wherein the light source includes an illumination device mounted for movement with the microscope.

22. The system of claim 1, wherein the light source includes an illumination device mounted on the microscope.

23. The system of claim 21, wherein the illumination device receives light from a remote light generator via a fibre optic cable.

24. The system of claim 21, wherein the illumination source is a light ring provided about the working microscope.

25. The system of claim 1, wherein the system includes 3D positioning means on which the microscope is mounted.

26. The system of claim 1, including a central control for automatically controlling the environmental chamber in accordance with a set load regime.

27. The system of claim 26, wherein the central control monitors the load on the sample, and obtains speckle image information for the sample at a set load.

28. The system of claim 1, wherein the microscope is automatically controlled, and includes a zoom lens actuator and an objective lens actuator for varying magnification and focusing.

29. The system of claim 1, wherein the system includes a central control for recording the position and magnification of a sample at the time when speckle image information is obtained, and for controlling the microscope to return to a re corded position and magnification to obtain further speckle image information.

30. The system of claim 1, wherein the speckle image information is analysed to find a maximum correlation coefficient C*:
$${C}^{*} ( {u}^{*} , {v}^{*} ) = \frac{{\sum }_{i = 1}^{m} {\sum }_{j = 1}^{n} [ f ( {x}_{i} , {y}_{j} ) - \overline{f} ] \cdot [ g ( {x}_{i}^{′} , {y}_{j}^{′} ) - \overline{g} ]}{\sqrt{{\sum }_{i = 1}^{m} {\sum }_{j = 1}^{n} {[ f ( {x}_{i} , {y}_{j} ) - \overline{f} ]}^{2}} \cdot \sqrt{{\sum }_{i = 1}^{m} {\sum }_{j = 1}^{n} {[ g ( {x}_{i}^{′} , {y}_{j}^{′} ) - \overline{g} ]}^{2}}}$$
where f(xᵢ,yⱼ) and g(x′ᵢ,yⱼ) are the gray-levels at points (xᵢ,yⱼ) and (x′ᵢ,y′ⱼ) on reference and deformed sub-images, respectively; and \overline{f} and \overline{g} are mean values of gray-levels at points (xᵢ,yⱼ) and (x′ᵢ,y′ⱼ) respectively.

31. The system of claim 30, wherein a cross-search correlation algorithm is used to find the maximum correlation coefficient C*.

32. The system of claim 30, wherein the maximum correlation coefficient is found by a line search, in which a search is made along both the x and y directions of the captured images for a maximum peak point for the correlation coefficient.

33. The system of claim 30, wherein discrete gray-level data obtained fro the speckle image information is smoothed using a bicubic spline interpolation method.

34. A method of deformation measurement, the method including the steps of placing a sample to be tested within an environmental chamber, illuminating the surface of the sample with incoherent light, obtaining speckle image information from the illuminated sample using a long-working distance microscope when the sample is under one or more load conditions, and analysing the image information obtained using a digital image speckle correlation technique.

35. A method for deformation measurement as claimed in claim 34, wherein the environmental test chamber includes an inner chamber in which the sample is mounted, a window that is transparent to illuminating radiation used in the test, a support for the sample, and thermal and/or humidity loading means for applying a thermal and/or humidity loading to the sample.

36. A method for deformation measurement as claimed in claim 34, wherein an apparatus for the deformation testing of an object is employed, the apparatus including a source of incoherent light for illuminating a sample under test, and a long-working-distance microscope for obtaining speckle image information from the illuminated sample surface, the image information being analysed using a digital image speckle correlation technique.

37. A method for deformation measurement as claimed in claim 34, wherein an apparatus for the deformation measurement of a sample is employed, the apparatus including an environmental chamber within which a sample under test is mounted in use, a source of incoherent light for illuminating the surface of the sample, and a means for obtaining speckle image information from the illuminated sample surface, the image information being analysed using a digital image speckle correlation technique.

38. A method for deformation measurement as claimed in claim 36, wherein the apparatus for the deformation measurement of a sample includes a source of incoherent light for illuminating the surface of the sample, and means for obtaining speckle image information from the illuminated sample surface, the image information being analysed using a digital image speckle correlation technique in which the speckle image information is analysed to find a maximum correlation coefficient C*:
$${C}^{*} ( {u}^{*} , {v}^{*} ) = \frac{{\sum }_{i = 1}^{m} {\sum }_{j = 1}^{n} [ f ( {x}_{i} , {y}_{j} ) - \overline{f} ] \cdot [ g ( {x}_{i}^{′} , {y}_{j}^{′} ) - \overline{g} ]}{\sqrt{{\sum }_{i = 1}^{m} {\sum }_{j = 1}^{n} {[ f ( {x}_{i} , {y}_{j} ) - \overline{f} ]}^{2}} \cdot \sqrt{{\sum }_{i = 1}^{m} {\sum }_{j = 1}^{n} {[ g ( {x}_{i}^{′} , {y}_{j}^{′} ) - \overline{g} ]}^{2}}}$$
where f(xᵢ,yⱼ) and g(x′ᵢ,y′ⱼ) are the gray-levels at points (xᵢ,yⱼ) and (x′ᵢ,y′ⱼ) on reference and deformed sub-images, respectively; and \overline{f} and \overline{g} are mean values of gray-levels at points (xᵢ,yⱼ) and (x′ᵢ,y′ⱼ) respectively.

39. A method for de formation measurement as claimed in claim 38, wherein a cross-search correlation algorithm is used to find the maximum correlation coefficient C*.

40. A method for deformation measurement as claimed in claim 38, wherein the maximum correlation coefficient is found by a line search is made along the perpendicular and horizontal directions of the captured images for a maximum peak point for the correlation coefficient.

41. A method for deformation measurement as claimed in claim 38, wherein discrete gray-level data obtained from the speckle image information is smoothed using a bicubic spline interpolation method.

452. A deformation measurement method for determining the deformation of a sample using digital image speckle correlation, including the steps of:
obtaining gray-level image information of two or more speckle images of the sample;
smoothing the gray-level image information using a bicubic spline interpolation method; and
determining the position of a correlation coefficient peak for the images from the smoothed gray-level image information.
